(19) United States
(12) Patent Application Publication
(10) Pub. No.: US 2022/0015353 A1
(43) Pub. Date: Jan. 20, 2022

(54) WATERFOWL DECOY FOR USE WITH REAL FEATHERED HIDES

(71) Applicant: Blake Boland, Barnett, MO (US)

(72) Inventor: Blake Boland, Barnett, MO (US)

(21) Appl. No.: 17/362,831

(22) Filed: Jun. 29, 2021

Related U.S. Application Data
(60) Provisional application No. 63/045,860, filed on Jun. 30, 2020.

(51) Int. Cl. A01M 31/06

(52) U.S. Cl. CPC A01M 31/06

(57) ABSTRACT

The present invention is a waterfowl decoy configured to be used with a real duck hide with feathers. The invention includes a number of features that enable it to protect the fragile hide from moisture, that allow it to be stored safely, and makes it simple to switch duck hides.

### CROSS REFERENCE TO RELATED APPLICATION

This application claims priority to U.S. Provisional Patent Application Ser. No. 63/045,860 filed on Jun. 30, 2020.

### FIELD

This document relates to the field of waterfowl decoys for hunting and other outdoor recreational use.

### BACKGROUND

Duck decoys should look as much like real ducks as possible to attract other ducks. One way to do this is by adding a real duck hide with feathers to the decoy. However, one challenge in doing this is creating a decoy that will protect the real duck hide from the water and allow for the real duck hides to be switched out for others to deal with different game or deterioration of the duck hide.

The use of a real duck hide with feathers poses a number of other challenges, including storage of a real duck hide with feathers and adherence of the duck hide to the decoy. The present invention overcomes the challenges mentioned.

### SUMMARY

The present invention allows for simple attachment of a variety of real duck hides to the top portion of the invention. This placement on the top portion protects the real duck hide that is attached after purchase of the decoy and is obtained separate from the purchase of the decoy. The present invention has a number of other inventive features that allow the decoy to be stored properly to prevent degradation.

A waterfowl decoy comprising a molded body having an upper side and a lower side and generally sharing an axis of symmetry in the x plane, the lower side having more mass than the upper side, the upper side generally comprising an ovular protrusion from the lower side, wherein the molded body is made from a floatable material, wherein the lower body extends beyond the upper body to form a ledge, and wherein the ledge includes a lip. The lip is a concave portion of the ledge.

In a preferred embodiment, the material of the molded body is polymer. The molded body is preferably created by injection molding.

In a preferred embodiment, the lower side is approximately 1.2x or more the mass of the upper side such that the upper side will not contact water when the waterfowl decoy is floating. In a more preferred embodiment, the lower side is approximately 1.5x or more the mass of the upper side.

In a preferred embodiment, the upper side has two concave indentions on opposite sides of the axis of symmetry. The concave indentions indented at least a one quarter inch at the deepest point.

In a preferred embodiment, the upper side has a plurality of bolts with washers configured to attach a duck skin with feathers.

In a preferred embodiment, a duck skin covers only the upper side and attaches below the lip flaring up from the ledge.

In a preferred embodiment, the lower side has one or more keels.

In a preferred embodiment, the lower side has three keels.

In a preferred embodiment, the lower side is painted to match the color of a waterfowl.

In a preferred embodiment, the duck skin is the duck skin of a mallard.

In a preferred embodiment, the upper side further comprises a head with a duck bill portion and wherein eyes on the head are painted.

In a preferred embodiment, the molded body includes all pieces as one integral body. However, the head may be configured to be screwed onto the neck.

In a preferred embodiment, the upper side generally matches the back, sides, neck and head of a waterfowl.

In a preferred embodiment, the waterfowl decoy material allows for the entry of thumbtacks. The thumbtacks can be used in addition to the bolts and washers or may be used as an alternative to the bolts and washers.

In a preferred embodiment, the bill of the bird is disproportionally large relative to the head.

A waterfowl decoy comprising a floatable plastic body having an upper side and a lower side the upper side configured to receive a real duck hide with feathers the lower side being larger in all directions at a plane where the upper side meets the lower side the lower side having three keels extending, the upper side having a neck portion and head portion, the head portion including a disproportionally large bill.

A duck decoy for covering with real duck hides comprising a floatable body having an upper side and a lower side, the floatable body constructed from a non-brittle copolymer three keels attached to the lower side of the body, each adapted to receive a weight the upper side further comprising a head portion and bill portion, and wherein the upper side except for the bill portion is structured and configured to receive a real duck hide attached with an anchoring mechanism the lower side configured to have at least 1.2x the volume of the upper side.

In a preferred embodiment, the upper side includes a neck portion, a head portion, and a bill portion, wherein the bill portion is disproportionally large relative to the rest of the upper side when a real duck hide with feathers is not attached.

### BRIEF DESCRIPTION OF DRAWINGS

FIG. 1 is a side view of the waterfowl decoy.

FIG. 2 is a front view of the waterfowl decoy.

FIG. 3 is a bottom view of the waterfowl decoy.

FIG. 4 shows a real duck hide on the waterfowl decoy.

### DETAILED DESCRIPTION OF DRAWINGS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the current invention. The following detailed description is, therefore, not to be taken in a limiting sense. The scope of the current invention is defined only by the claims, along with the full scope of equivalents to which such claims are entitled.

In this description, references to “one embodiment”, “an embodiment”, “a preferred embodiment”, or “embodiments” mean that the feature or features being referred to are included in at least one embodiment of the technology. Separate references to “one embodiment”, “an embodiment”, “a preferred embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

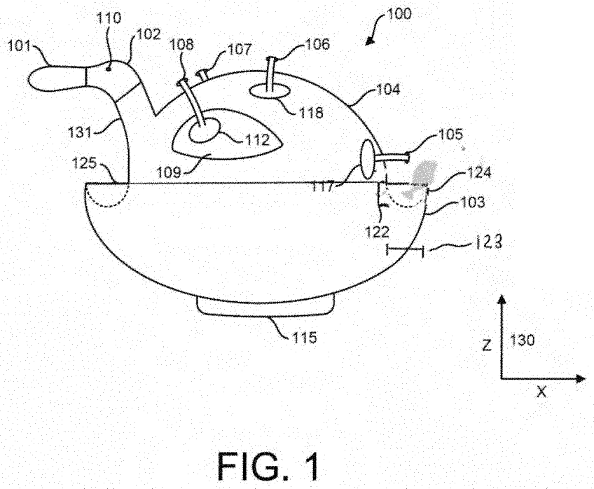

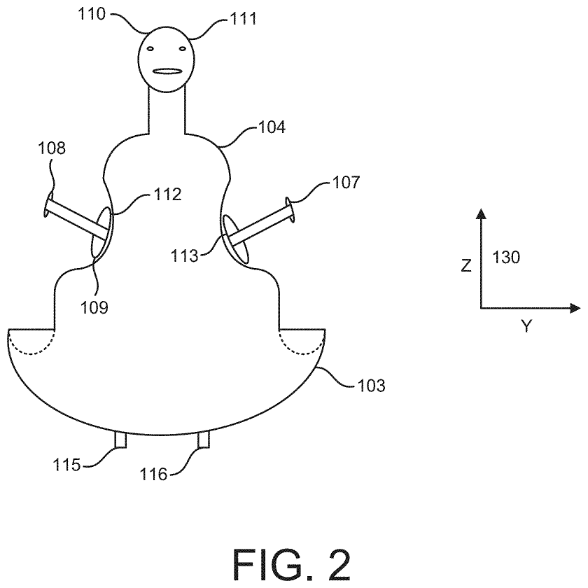

FIG. 1 and FIG. 2 show the waterfowl decoy 100 without a feathered hide. The decoy 100 is comprised of a molded body having an upper portion 104 and a lower portion 103. In the preferred embodiment, the lower portion has more mass than the upper portion 104. In a most preferred embodiment, the lower portion is one and one half times or more the mass of the upper portion. The molded body is generally symmetrical along an axis of symmetry in the z plane 130.

The upper portion 104 includes a bill 101 extending from a head 102 extending from a neck 131. The bill 101 is disproportionally large relative to the head 102 as compared to a live waterfowl. The bill 101 is longer than the head 102. Ideally, the bill 101 is two and one-half inches and the head measures two inches from the back of the head 102 to the front of the head 102. In a preferred embodiment, the bill 101 is between ten and thirty percent longer than the head 102. In the most preferred embodiment, the bill is twenty percent longer than the head 102. The head 102 has two waterfowl eyes 110 and 111.

The upper side 104 includes attachment means for attaching a feathered hide to the decoy 100. In a preferred embodiment, a plurality of bolts 105, 106, 107 and 108 and a plurality of washers 112, 118, 119 and 113 are used as the means for attaching the feathered hide. The attachment may be supplemented or substituted with thumb tacks. The molded body is made from a material allowing thumbtacks to be held in place. The preferred material is made from a two part liquid that can be poured into a mold. When it sets, it is a rigid urethane foam that is closed cell. The upper side also includes two concave indentations 109 and 114 that approximate the size of a waterfowl wing.

The lower portion 103 extends beyond the upper portion 104 to create a ledge 125. The ledge has a lip 124 that flares up such that the ledge extends a lateral dimension 123 in the x plane 130 and has a vertical trough that has a depth dimension 122 in the z plane 130. In the preferred embodiment, the depth dimension 122 is between ⅛ inches and ¼ inches and the lateral dimension is between 1 inch and 1 and ½ inches for drakes and ½ inches and 1 inch for hens. When a feathered duck hide is attached to the molded body, the duck hide will lie just below the top of the lip.

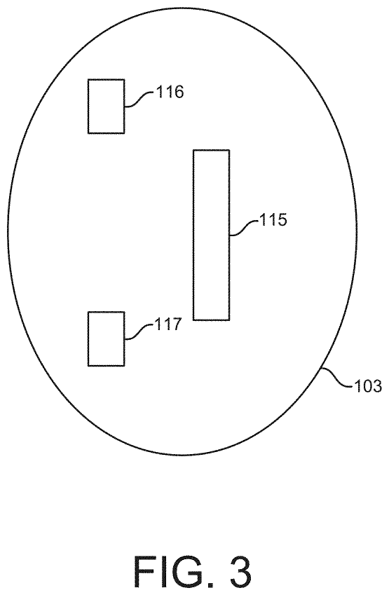

Referring to FIG. 3, the lower portion 103 has a plurality of keels that extend below the lower portion 103. In a preferred embodiment, the lower portion 103 has three keels. In the most preferred embodiment, the lower portion has a long keel 115 adjacent to two smaller keels 116 and 117.

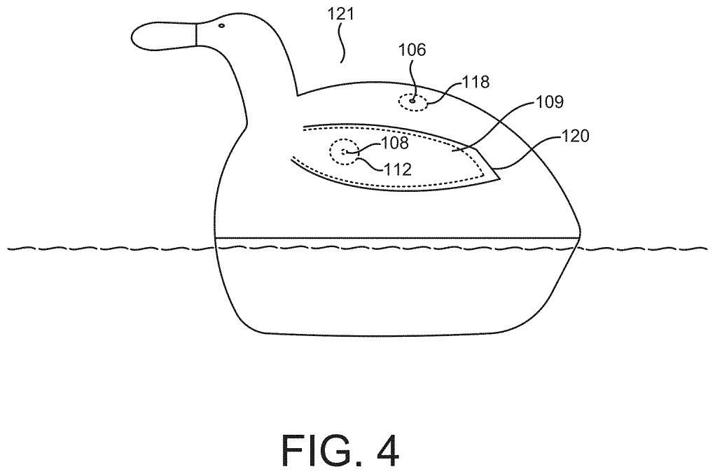

FIG. 4 shows the embodiment with a feather duck hide 121.The molded body is configured to be fitted with a real duck hide with feathers. The real duck hide will fit over the upper portion 104 of the decoy. The attachment means will penetrate the duck hide and attach to the upper portion 104 of the decoy. In the preferred embodiment, a plurality of bolts 105 106, 107 and 108 will penetrate the hide and attached to the decoy. Washers 112, 118, 119 and 113 will hold the duck hide in place. Other attachment means can be used and a bolt with a large head could substitute for the washers. Thumbtacks are one example of an alternative attachment means, and can also function as a supplemental attachment means. A user can move the feathers or adjust the feathers to hide the washers 112, 118, 119 and 113.

Nearly all of the lower portion 103 sits below the water line when the decoy is deployed in a body of water. The lip 124 should be just above the waterline. The lip functions to keep water away from the real duck hide and is sized to prevent moderate ripples from wetting the hide.

I claim:

1. A waterfowl decoy comprising
a molded body having an upper side and a lower side and generally sharing an axis of symmetry in the z plane,
the lower side having more mass than the upper side
the upper side generally comprising an ovular protrusion from the lower side
wherein the molded body is made from a floatable material.
wherein the lower body extends beyond the upper body to form a ledge, and
wherein the ledge includes a lip.

2. The waterfowl decoy of claim 1, wherein the material of the molded body is polymer.

3. The waterfowl decoy of claim 1, wherein the lower side is approximately one and two-tenths times the mass of the upper side such that the upper side will not contact water when the waterfowl decoy is floating.

4. The waterfowl decoy of claim 1, wherein the upper side has two concave indentions on opposite sides of the axis of symmetry.

5. The waterfowl decoy of claim 1, wherein the upper side has a plurality of bolts with washers configured to attach a duck skin with feathers.

6. The waterfowl decoy of claim 3, further comprising a duck skin that covers only the upper side.

7. The waterfowl decoy of claim 1, wherein the lower side has one or more keels.

8. The waterfowl decoy of claim 1, wherein the lower side has three keels.

9. The waterfowl decoy of claim 1, wherein the lower side is painted to match the color of a waterfowl.

10. The waterfowl decoy of claim 4, wherein the duck skin is the duck skin of a mallard.

11. The waterfowl decoy of claim 1, wherein the upper side further comprises a head with a duck bill portion and wherein eyes on the head are painted.

12. The waterfowl decoy of claim 1, wherein the ledge extends about one inch from the top portion.

13. The waterfowl decoy of claim 1, wherein the upper side generally matches the back, sides, neck and head of a waterfowl.

14. The waterfowl decoy of claim 1, wherein the waterfowl decoy material allows for the entry of thumbtacks.

15. The waterfowl decoy of claim 1, wherein the duck bill is longer than the head.

16. A waterfowl decoy comprising
a floatable plastic body having an upper side and a lower side
the upper side configured to receive a real duck hide with feathers
the lower side being larger in all directions at a plane where the upper side meets the lower side
the lower side having three keels
the upper side having a neck portion and head portion, the head portion including a disproportionally large bill.

17. The waterfowl decoy of claim Error! Reference source not found., wherein the upper side has a plurality of bolts configured to hold a real duck hide with feathers.

18. The waterfowl decoy of claim 16, wherein the upper side has two concave indentations configured to receive wing areas on a real duck hide with feathers.

19. A duck decoy for covering with real duck hides comprising
a floatable body having an upper side and a lower side, the floatable body constructed from a non-brittle copolymer
three keels attached to the lower side of the body, each adapted to receive a weight
the upper side further comprising a head portion and bill portion, and wherein the upper side except for the bill portion is structured and configured to receive a real duck hide attached with an anchoring mechanism
the lower side configured to have at least 1.233 the volume of the upper side.

20. The duck decoy of claim 19, wherein the upper side includes a neck portion, a head portion, and a bill portion, wherein the bill portion is disproportionally large relative to the rest of the upper side when a real duck hide with feathers is not attached.
